(19) United States
(12) Patent Application Publication
(10) Pub. No.: US 2016/0267119 A1
(43) Pub. Date: Sep. 15, 2016

(54) INDEX BUILDING IN HYBRID DATA SYSTEM

(71) Applicant: Microsoft Technology Licensing, LLC, Redmond, WA (US)

(72) Inventors: Nikhil Teletia, Madison, WI (US); Thanh Do, Madison, WI (US); Alan Halverson, Verona, WI (US)

(21) Appl. No.: 14/657,871

(22) Filed: Mar. 13, 2015

(51) Int. Cl. G06F 17/30

(52) U.S. Cl. CPC G06F 17/30336; G06F 17/30595; G06F 17/30864

(57) ABSTRACT

The building of an index in a hybrid data system that includes both relational data associated with a relational database system, and external data that is outside of the relational database system in an external data source. The building of the index includes the generating of an external data index of unit portions of the external data, the unit portion being measured common to multiple different formats of the external data. The external data index is usable to more quickly find unit portions that match one or more search criteria directed to the relational database system even though the external data source is outside of the relational database system. Queries may be evaluated in the context of this index to identify relational data and unit portion sets that are relevant to the query.

### BACKGROUND

The amount of information available to users over the Internet or via corporate networks is practically limitless, which is why today's era is often termed the “information age”. In addition, enterprises often deal with enormous quantities of data. It often becomes difficult for an entity (such as an individual or enterprise) to filter through all of the voluminous amounts of available information to find information that is most relevant to that entity at any given time.

One conventional solution is the relational database system, in which the system knows information about the structure and relationships of data. Furthermore, the data is stored in a highly efficient manner. Relational database systems also have query engines that leverage the structure and relationships of the data to process a wide variety of queries. Thus, data may be efficiently accessed in a relational database system in a variety of different ways. Before data is added to a relational database system, the system should thus be notified of the structure of the data, and its relationship with the existing data within the relational database system.

However, many times, data is available with very little known about the structure of the data. Sometimes such unstructured data may be very large. There are presently repositories available where entities may place data without identifying the structure of the data. Rather, the data is simply given a name. Nevertheless, conventionally such repositories are quite intelligent taking care of distributing the data in a load balanced way, often splitting the data along certain boundaries, and replicating the data so as to provide a certain redundancy in case of corruption or hardware failure. Sometimes such repositories offer some level of computation over the data so as to allow the type and schema of the data to become later known.

Some conventional technologies allow relational database systems and such external repositories to be combined. In that case, some structure regarding the data repository might be stored within the relational database system. Queries can even be run across such combined databases such that results are returned both from the relational database system, and from the external repository.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the building of an index in a hybrid data system that includes both relational data associated with a relational database system, and external data that is outside of the relational database system in an external data source. The building of the index includes the generating an external data index of unit portions of the external data, the unit portion being measured common to multiple different formats of the external data. Queries may be evaluated in the context of this index to identify relational data and unit portion sets that are relevant to the query. The external data index is usable to more quickly find unit portions that match one or more search criteria directed to the relational database system even though the external data source is outside of the relational database system.

For each unit portion, the generation of the external database index involves determining a name in the unit portion to index by, identifying and reviewing a structured representation of the unit portion and name, and then mapping a value of the of the name to the unit portion depending on the result of the review. Since the unit portion is common to multiple different formats of data, the building process may be more uniform across data of different formats. Furthermore, the structured representations themselves might be represented in a common way (e.g., in a relational database table) thereby providing further uniformity to the index building process, regardless of the type of external data being indexed.

Some embodiments described herein also related to a method for processing a query involving external data that is outside of a relational database system. The query is evaluated in the context of an index that maps a value of a name to a unit portion of the external data. Again, the unit portion is measured common to multiple different formats of the external data. Based on the evaluation, an identified unit portion set is identified as relevant to the query. In some embodiments, the unit portion set is the null set, and perhaps the external data index itself is sufficient to return a response. In other cases, the unit portion set includes one or more unit portions. The unit portions may be accessed in order to return a response to the query. For instance, a give unit portion may be accessed by importing the unit portion into the relational database system, or by formulating intermediate data that is compatible with the relational database system. The response may also integrate results from part of the query plan that was executed on the relational data itself.

This summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed;

FIG. 2 illustrates a hybrid data system that includes a relational database system and an external data source that is outside of the relational database system;

FIG. 3 illustrates a flowchart of a method for building an index for a unit portion in a hybrid data system;

For instance, FIG. 4 shows a specific example process flow showing an implementation of method of FIG. 3 performed on actual data;

FIG. 5 illustrates a flowchart of a method for augmenting the external data index after a new unit portion is added to the external data system;

FIG. 6 illustrates a method for changing the external index after a unit portion is removed from the external database;

FIG. 7 illustrates a flowchart of a method for processing a query involving external data that is outside of a relational database system; and

FIG. 8 illustrates a flowchart of a method for accessing a unit portion set; and

FIG. 9 illustrates a flowchart of a method 900 for identifying a unit portion set that is relevant to the query in a context in which the external data index is stale.

### DETAILED DESCRIPTION

At least some embodiments described herein relate to the building of an index in a hybrid data system that includes both relational data associated with a relational database system, and external data that is outside of the relational database system in an external data source. The building of the index includes the generating an external data index of unit portions of the external data, the unit portion being measured common to multiple different formats of the external data. Queries may be evaluated in the context of this index to identify relational data and unit portion sets that are relevant to the query. The external data index is usable to more quickly find unit portions that match one or more search criteria directed to the relational database system even though the external data source is outside of the relational database system.

For each unit portion, the generation of the external database index involves determining a name in the unit portion to index by, identifying and reviewing a structured representation of the unit portion and name, and then mapping a value of the of the name to the unit portion depending on the result of the review. Since the unit portion is common to multiple different formats of data, the building process may be more uniform across data of different formats. Furthermore, the structured representations themselves might be represented in a common way (e.g., in a relational database table) thereby providing further uniformity to the index building process, regardless of the type of external data being indexed.

Some embodiments described herein also related to a method for processing a query involving external data that is outside of a relational database system. The query is evaluated in the context of an index that maps a value of a name to a unit portion of the external data. Again, the unit portion is measured common to multiple different formats of the external data. Based on the evaluation, an identified unit portion set is identified as relevant to the query. In some embodiments, the unit portion set is the null set, and perhaps the external data index itself is sufficient to return a response. In other cases, the unit portion set includes one or more unit portions. The unit portions may be accessed in order to return a response to the query. For instance, a given unit portion may be accessed by importing the unit portion into the relational database system, or by formulating intermediate data that is compatible with the relational database system. The response may also integrate results from part of the query plan that was executed on the relational data itself.

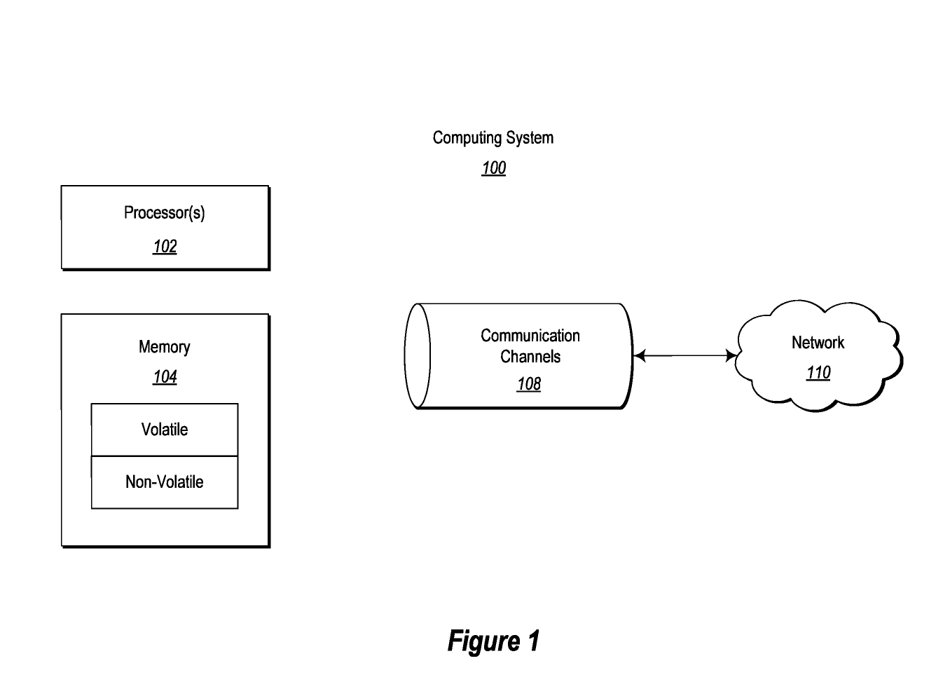

Some introductory discussion of a computing system will be described with respect to FIG. 1. Then, the structure and operation of embodiments described herein will be presented with respect to subsequent figures.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors (of the associated computing system that performs the act) direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other computing systems over, for example, network 110.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. The computer executable instructions may be, for example, binaries or even instructions that undergo some translation (such as compilation) before direct execution by the processors, such as intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

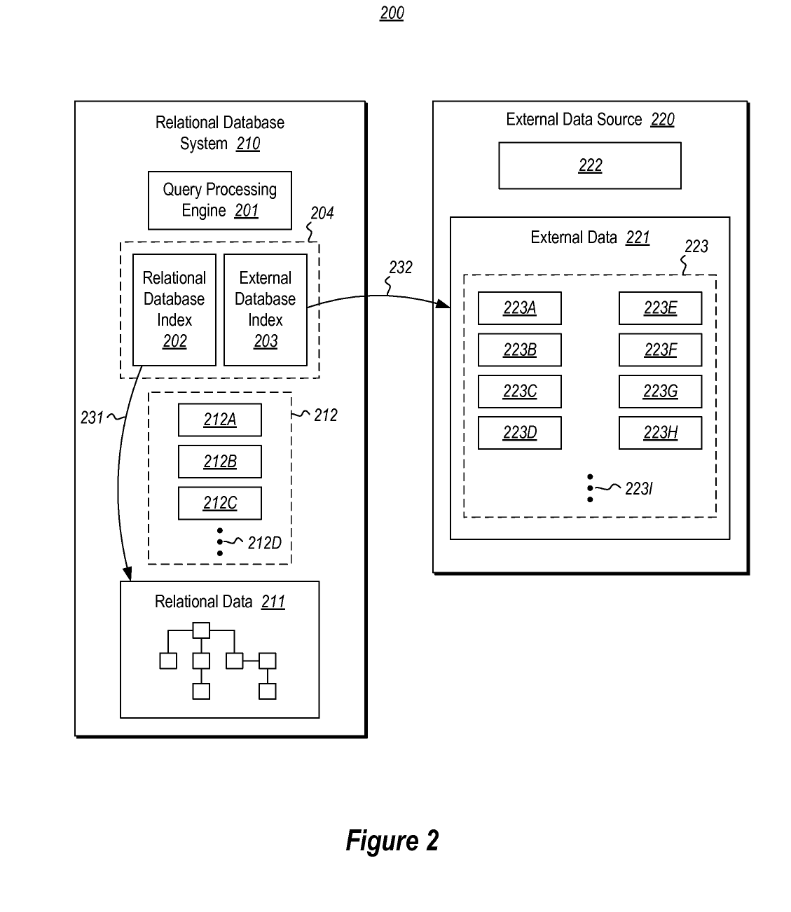

FIG. 2 illustrates a hybrid data system 200 in which the principles described herein may be employed. The hybrid data system 200 includes a relational database system 210 that includes relational data 211, and an external data source 220 that is outside of the relational database system and that includes external data 221. For instance, the external data 221 may be non-relational data. In some embodiments, the external data source 220 may even be a data store where unstructured data may be placed. The external data source 220 might include logic components 222 that partition data (such as files) into segments, distribute data, and provide redundancy to the data. For instance, perhaps data may be stored within the external data store by just providing a name or identifier for the data, and without giving any structure of the data. Perhaps later, structure may be applied to that data by the logic components 222 or by other components outside of the external data store 220.

An example of an external data source 220 is the APACHE™ HADOOP® data store that implements the HADOOP protocol. Various conventional solutions integrate Structured Query Language (SQL) relational databases with HADOOP data stores. Examples of such SQL over HADOOP hybrid data systems include solutions such as Impala, HAWQ, Stinger, SQL-H, Hadapt, and PolyBase.

The external data 221 is illustrated as including eight unit portions 223A through 223H. In reality, the external data source 220 might be quite large such that there may be millions or billions or more of unit portions within the data store. This possibility is symbolized by the ellipses 223I. The unit portions 223A through 223I may hereinafter be referred to collectively as “unit portions 223”.

The unit portion is measured common to multiple different formats of the external data. For instance, unit portion may be the basic unit of unstructured data initially recognized by the external data source. As an example only, the unit portion might be a file. Alternatively or in addition, the unit portion might be a file portion representing the result of the external data source 220 segmenting a file. For instance, HADOOP data stores often segment larger files into constitute unit portions called “blocks”. While the unit portions 223 may each initially be unstructured, they each still represent data of a particular format, and thus structure may later be added upon the data to reveal more about that format. Accordingly, the unit portions 223 may represent a diversity of data formats.

Each of at least some (e.g., all) of the unit portions 223 have a corresponding structured representation that may be referenced to apply and understand format or schema regarding the underlying unit portion. Although not required, a single structured representation may be used to represent the structure of multiple of the unit portions. This might be appropriate if, for example, the multiple unit portions have a common format and schema. For instance, suppose structured representation 212A corresponds to a single unit portion 223A. However, suppose structured representation 212B corresponds to three unit portions 223B through 223D, as they may have a similar format and schema, at least as far as the scope of the structured representation 212B is concerned. Furthermore, suppose structure representation 212C corresponds to four unit portions 221E through 221H, as they may have a similar format and schema, at least as far as the scope of the structured representation 213B is concerned. The ellipses 212D represent that there may be more structured representations within the relational database system 210. The structured representations 212A through 212D may be collective referred to hereinafter as “structured representations 212”.

The relational database system 210 includes a query processing engine 201 that serves to receive queries, formulate a query plan, execute the query plan, and return the query results. In distributed databases, the execution of the query plan involves segmenting the query plan, and assigning different nodes of the database to perform their portions of the query plan, and gather and consolidate the results. In one embodiment, the query processing engine is a Parallel Data Warehouse (PDW) component.

The relational database system 210 also includes a relational database index 202 that identifies locations of data within the relational data 211 based on values of one or more names (e.g., parameters). This indexing function is represented by arrow 231. There is also an external data index 203 that identifies locations (e.g., the identity of unit portions) of data within the external data 221 based on values of one or more names (e.g., parameters). This indexing function is represented by arrow 232. The relational data index 202 and the external data index 203 may be collectively referred to as index 204. The query processing engine 201 uses the index 204 to more quickly locate data that matches a query directed at the query processing engine. Since the index 204 is a hybrid index, this is true regardless of whether the data that satisfies the query is within the relational data 211, the external data 221, or both. In some cases, the query may be satisfied from information within solely the index 204 itself without even synchronously accessing the relational data 221 and the external data 222.

Although the external data index 203 is illustrated as being within the relational database system 210, that need not be the case. Alternatively or in addition, the external data index 203 may be within the external data source 220, some other location, or distributed amongst combinations of the above.

Relational database indexes are quite common in relational database systems are quite common. However, building external database indexes is a little more difficult, especially if the external data is first placed within the external data store without any structure, and without knowing anything initially about the format, schema or structure of the unit portions within that external data. However, the structured representations 212 play an important role in the building of the external database index 203. In fact, the use of structured representations 212 allows for the index building process of the external data index to have more uniformity regardless of the structure and schema of the underlying unit portion.

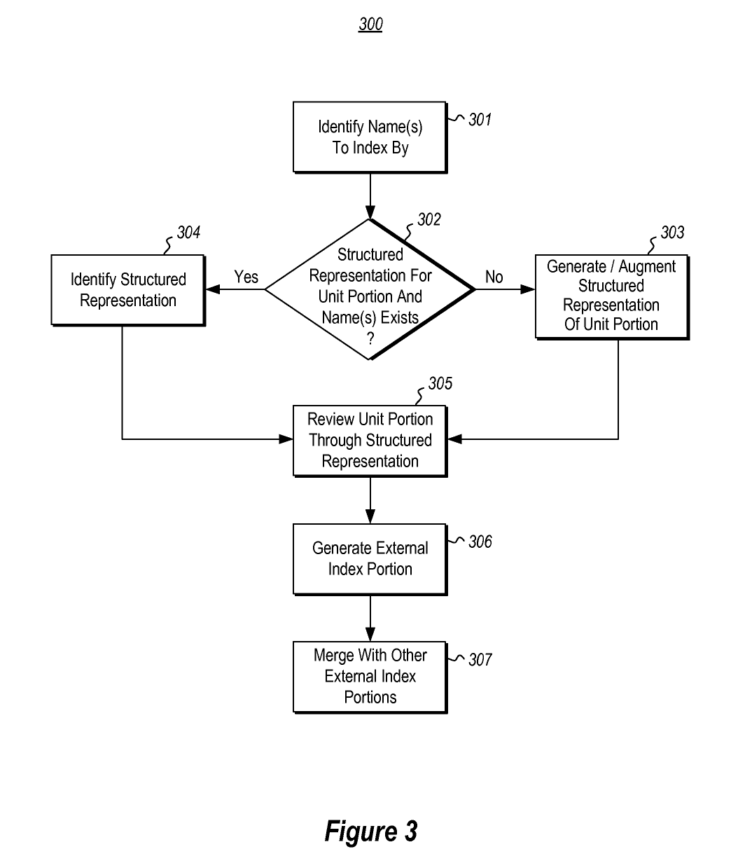

FIG. 3 illustrates a flowchart of a method 300 for building an index in a hybrid data system. For instance, the method 300 may be used to build the external database index 203 and potentially further the hybrid index 204 in the hybrid data system 200. Accordingly, the method 300 of FIG. 3 will now be described with reference to the hybrid data system 200 of FIG. 2. The result of the method 300 is an external data index for one of the unit portions 223. However, the method 300 may be performed multiple times in order to obtain an external data index for multiple, and even perhaps all of, the unit portions 223. Furthermore, the method 300 may be performed multiple times even for a given unit block if one or more new names are to be indexed in addition to those one or more names previously indexed. For instance, as the method 300 uses a structured representation that allows a structured view into the unit block revealing at least the structure relating to the name or names (and their associated values) to be indexed, it may take some time before the hybrid system obtains sufficient information to be able to build or obtain such a structured representation. In any case, the method 300 may be performed within the relational database system 210, within the external data source 220 (e.g., by logic components 222), at some other location, or be distributed amongst combinations of the above.

The method 300 begins by identifying the name or names to index by for a given unit portion (act 301). Then, it is determined whether a structured representation for the unit portion exists (decision block 302) in which the name or names to index by are represented. If not (“No” in decision block 302), then the method 300 generates such a structured representation of the unit portion (act 303). For instance, if there exist no structured representations at all for the unit portion, then the structure representation is created in which at least the name or names to be indexed by are represented. If there did exist a structured represented for the unit portion, but one or more of the names to index by are not represented in that structured representation, then the structured representation may perhaps be augmented to include those one or more additional names. In order to determine the structured representation, the provider or owner of the unit portion might divulge some information about the structure of the unit portion, and/or the structure could be inferred based on some information known to the hybrid data system 300.

If there is already a structured representation (“Yes” in decision block 302) for the unit portion in which the name or names to index by are represented, that structured representation is identified (act 304). Regardless of whether the structured representation was generated or augment (act 303) or was just identified (act 304) for that given unit portion, the corresponding structured representation is then reviewed (act 305). In particular, the structured representation for the unit portion represents a view on the unit portion whereby structure can be seen at least with respect to the name(s) within the scope of the structured representation. Accordingly, values of those names may also be ascertained. Thus, for each name to be indexed by, in response to viewing the unit portion via the structured representation, an external index may be generated (act 306) that maps actual values of one or more names to the unit portions. That external index may be merged (act 307) with any other external indexes that was created by prior iterations of method 300 for other unit portions.

Since the unit portion is common to multiple different formats of data, the building process may be more uniform across data of different formats. Furthermore, the structured representations themselves might be represented in a common way (e.g., in a relational database table) thereby providing further uniformity to the index building process, regardless of the type of external data being indexed.

FIG. 4 shows a specific example process flow 400 showing an implementation of method 300 performed on actual data. The process flow proceeds from left to right. The process begins by gaining a view on a unit portion within the external data source. For instance, in FIG. 4, the external data system is illustrated as being a Hadoop Distributed File System (HDFS) that contains three unit portions. Presently, the unit portion 411 is being viewed. Note that the unit portion 411 is being viewed as structured data. While the unit portion 411 might include further structure outside of view, the structure representation allows this portion of the unit portion 411 to be viewed in structural form. For instance, the unit portion 411 is an employee table that lists by column from left to right 1) the employee identifier, 2) the employee name, and 3) the department ID. This view is obtained by performing through act 305 in FIG. 3.

Here, the name “department identifier” or “DeptID” is the name to index by. This would have been identified in act 301. As an example, this indexing operation may have been performed by an explicit command such as “Create Index Idx_Id on HDFS_Employee(DeptID)”. Such a command might actually cause method 300 to be performed with respect to each of the unit portions 411, 412 and 413. The structure 402 represents the DeptID column which represents all of the name value pairs for the name DeptID in that unit portion 411. A Q-table 403 may then be formed which associates the unit portion identified as an index key. An index landing table 404 then aggregates the Q-table such that there is a row for each unique value for the name, and an additional column represents how many instances of that value were found.

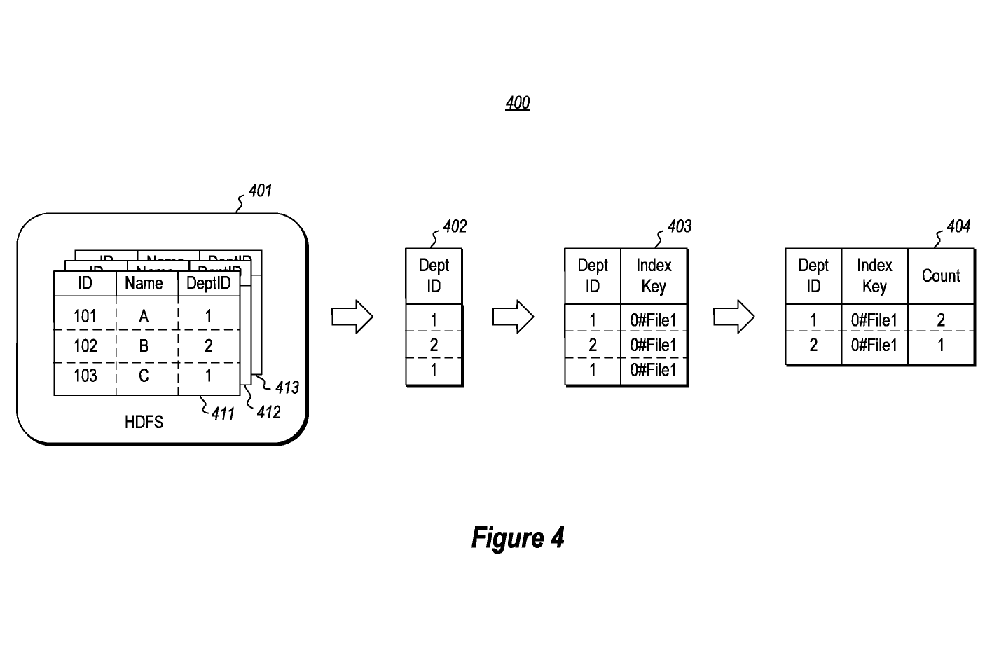

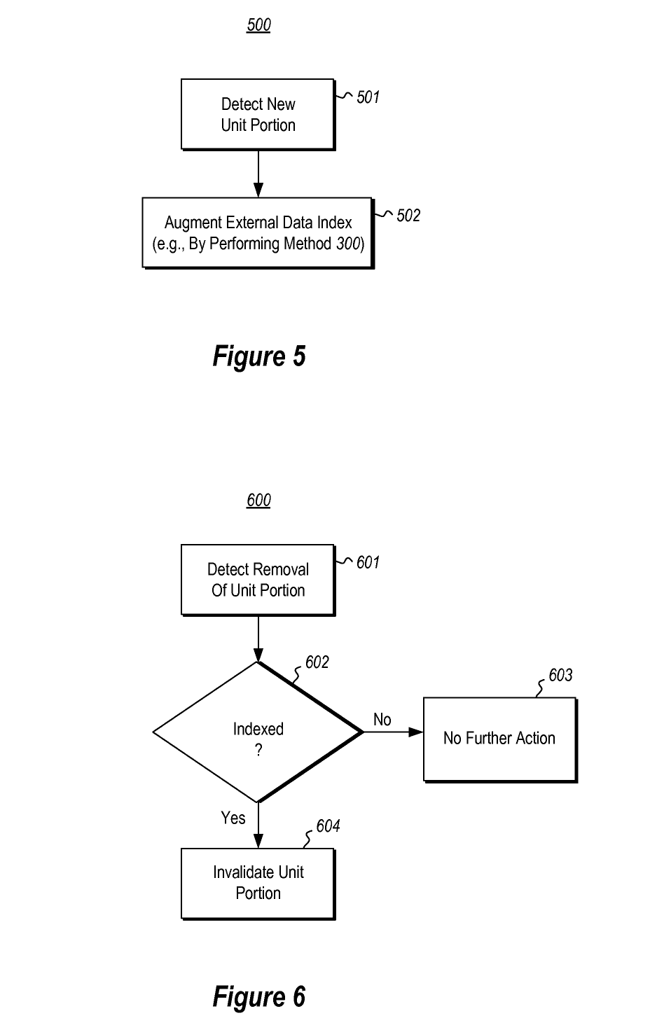

The external data index 203 may be updated when new unit portions are added to the external data 221. However, recall that it may be some time before any of the structure of the added unit portion is understood sufficiently to be able to formulate a structured representation 212 within the relational database system. Accordingly, it may be some time before the new unit portion is evaluated for indexing. Nevertheless, FIG. 5 illustrates a flowchart of a method 500 for augmenting the index after a new unit portion is added to the external data system. After detecting that a new unit portion is in the external data source (act 501), the external index is augmented (act 502) by performing the method 300. However, recall that the method 300 relies sufficient information from which to generate an index by the name desired to be indexed by. Thus, there may be considerable time elapsed between the detection of the new unit portion (act 501), and the evaluation of the new unit portion for indexing by any given name (act 502). That manner in which queries may be responded to in the interim will be described with respect to FIG. 9 below.

The external data index 203 may also be updated when a unit portion is removed from the external database. FIG. 6 illustrates a method 600 for changing the external index after a unit portion is removed from the external database. First, the removal of the unit portion is detected (act 601). If the unit portion had not yet been indexed (“No” in decision block 602), no further action (act 603) is needed to update the external data index. For instance, perhaps the unit portion was still lying in limbo between acts 501 and 502 in FIG. 5. However, if the unit portion had been indexed (“Yes” in decision block 602), then the mapping of any values of any of the indexed names are invalidated (act 604). For instance, perhaps the entire unit portion is marked as invalid so that it is not included in any query results.

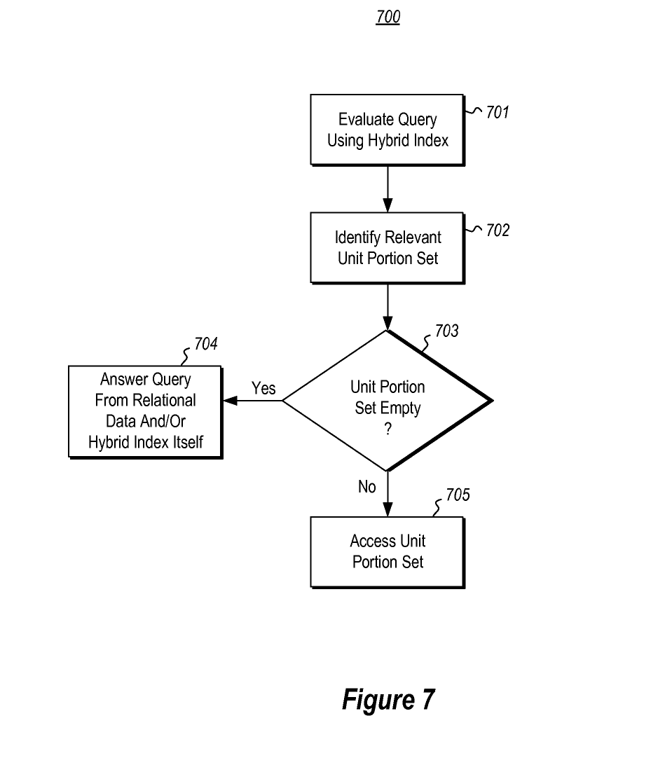

Of course, now that the hybrid index 204 is created, it is to be put to good use. FIG. 7 illustrates a flowchart of a method 700 for processing a query involving external data that is outside of a relational database system. First the query is evaluated (act 701) in the context of the hybrid index. Based on the evaluation, with respect to the external data store 220, a unit portion set is identified (act 702) as being relevant to the query. A separate query may be performed on the relational data 211. If the unit portion set is empty (i.e., the null set) (“Yes” in decision block 703), then the query response may perhaps be generated from the relational data 211 or perhaps just content of the hybrid index itself (act 704). Otherwise, the query may simply return with a null response or an error. For instance, in the context of FIG. 4, if there was a query asking if there exist any employees that are in DeptID 1, then no unit portions would need be accessed at all, since the information is already present within the index landing table 404. Alternatively, there may be one or more unit portions that are identified as being relevant to the query (“No” in decision block 703). In that case the unit portions of the unit portion set are accessed (act 705).

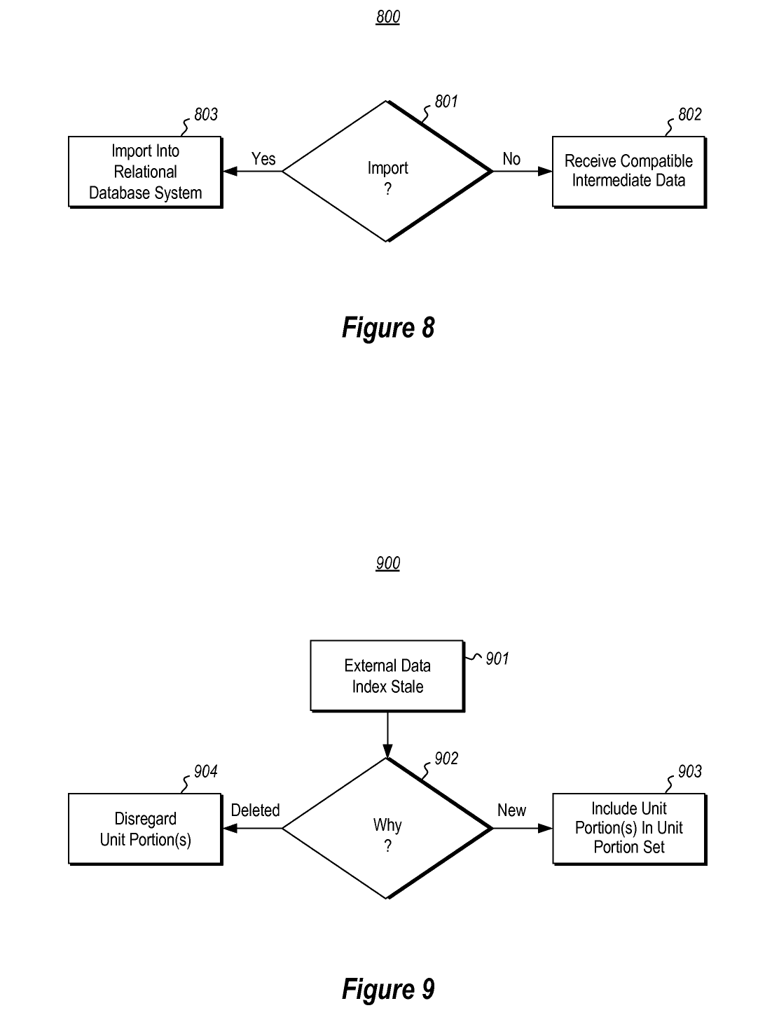

FIG. 8 illustrates a flowchart of a method 800 for accessing a unit portion set. The method 800 represents one example of the act 705 of FIG. 7. The method 800 begins by deciding whether or not to import the unit portion (decision block 801). If importation is to occur (“Yes” in decision block 801), the unit portion is imported into the relational database system (act 802). The imported unit portion may be within the relational database system for purposes of this query only, or perhaps might be permanently imported into the relational data 211.

If importation is not to occur (“No” in decision block 801), then intermediate data that is compatible with the relational database system is imported into the relational data (act 803). The generation of the intermediate data may be performed by, for instance, the logic component 222 of the external data source in response to receiving a query plan from the query processing engine 201. Either way, (in the case of importing or not importing), the relational database system 210 has relational data through which it can reason and respond to the query based on the information of the unit portion that is now in relational and structural form.

The decision on whether or not to import a unit portion may depend on how many unit portions are in the unit portion set. By indexing on the external data, this increases the chance that there may be fewer unit portions to import, especially for a narrowly tailored query.

FIG. 9 illustrates a flowchart of a method 900 for identifying a unit portion set that is relevant to the query in a context in which the external data index is stale. First, it is determined that the external data index is stale (act 901). Then it is determined why (decision block 902). For instance, perhaps the external index is stale because a new unit portion has been added (“New” in decision block 902). In that case, the new unit portion is included (act 903) within the unit portion set generated as a result of the query out of an abundance of caution. As an example, perhaps there are one or more unit portion that are in limbo between act 501 and act 502 for the name or names that are relevant to the query. Such newly added unit portions might be included in every unit portion set that is responsive to any query that cannot be answered by the hybrid index itself.

On the other hand, perhaps the unit portions are stale because one or more unit portions have been removed from the external data (“Deleted” in decision block 902). In that case unit portion is disregarded (act 904) when identifying the unit portion set that is responsive to any query.

Accordingly, a hybrid data indexing building technique has been described in which the manner in which the index is build does not fundamentally depend on the nature of the underlying unit portions. The same building component may be used for a wide variety of unit portions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for building an index in a hybrid data system that includes both relational data associated with a relational database system, and external data that is outside of the relational database system in an external data source, the method comprising:
an act of determining a name in the identified structured representation to index by;
an act of generating an external data index of a plurality of unit portions of the external data that indexes by the determined name, the unit portion being measured common to a plurality of different formats of external data, the plurality of unit portions including unit portions of multiple different formats, the external data index usable to more quickly find unit portions that match one or more search criteria directed to the relational database system even though the external data source is outside of the relational database system, the act of generating the external data index comprising the following for each unit portion of the plurality unit portions:
an act of identifying a structured representation of the unit portion, the structured representation including a structural context of the determined name;
an act of reviewing the identified structured representation; and
in response to the act of reviewing and determining, an act of generating a portion of the external data index that maps a value of the name to the unit portion of the external data.

2. The method in accordance with claim 1, further comprising:
an act of merging the external data index with a relational database index associated with the relational database system.

3. The method in accordance with claim 1, further comprising the following for each of at least one of the plurality of unit portions:
an act of generating the structured representation of the unit portion.

4. The method in accordance with claim 1, further comprising:
an act of detecting a new unit portion in the external data source;
an act of determining a name in the identified structured representation of the new unit portion to index by;
in response to detecting the new unit portion in the external data source, an act of augmenting the external data index by performing the following:
an act of identifying a structured representation of the new unit portion, the structured representation including a structural context of the determined name;
an act of reviewing the identified structured representation of the new unit portion;
an act of augmenting the external data index such that a value of the name in the identified structured representation of the new unit portion maps to the new unit portion.

5. The method in accordance with claim 1, further comprising:
an act of detecting that a unit portion has been or is to be removed from the plurality of unit portions; and
in response to the act of detecting that the unit portion has been or is to be removed, an act of invalidating the mapping of a value of the name for that unit portion to that unit portion.

6. The method in accordance with claim 1, the unit portion being a file portion.

7. The method in accordance with claim 1, the unit portion being a file.

8. The method in accordance with claim 1, the external data index being within the relational database system.

9. The method in accordance with claim 1, the external data index being within the external data source.

10. The method in accordance with claim 1, the name being a first name, the method further comprising the following for each of at least one of the plurality of unit portions:
an act of determining a second name in the identified structured representation to index by; and
in response to the act of reviewing and determining, an act of generating the portion of the external data index that maps a value of the second name to the unit portion of the external data.

11. A method for processing a query involving external data that is outside of a relational database system, the method comprising:
an act of evaluating the query in the context of an index that maps a value of a name to a unit portion of a plurality of unit portions of the external data, the unit portion being measured common to a plurality of different formats for external data; and
based on the act of evaluating, an act of identifying a unit portion set that is relevant to the query.

12. The method in accordance with claim 11, further comprising:
an act of determining that the plurality of unit portions is stale.

13. The method in accordance with claim 12, the new unit portion being stale because one or more new unit portions have been added to the plurality of unit portions, the method further comprising:
an act of including the one or more new unit portions in the unit portion set that is relevant to the query.

14. The method in accordance with claim 12, the new unit portion being stale because one or more unit portions have been deleted from the plurality of unit portions, the method further comprising:
an act of disregarding the one or more unit portions when identifying the unit portion set that is relevant to the query.

15. The method in accordance with claim 11, the unit portion set being the null set.

16. The method in accordance with claim 11, the method further comprising:
an act of determining that the query may be responded to from the external data index itself, without accessing any of the identified one or more portions.

17. The method in accordance with claim 11, further comprising:
an act of accessing the identified one or more portions.

18. The method accordance with claim 17, the act of accessing the identified one or more portions comprising:
an act of importing at least one unit portion of the identified unit set into the relational database system.

19. The method in accordance with claim 17, the act of accessing the identified one or more portions comprising:
an act of causing at least one portion of the identified unit portion set to be read to formulate intermediate data that is compatible with the relational database system.

20. A computer program product comprising one or more computer-readable storage media having thereon computer-executable instructions that are structured such that, when executed by one or more processors, cause the computing system to perform a method for building an index in a hybrid data system that includes both relational data associated with a relational database system, and external data that is outside of the relational database system in an external data source, the method comprising:
an act of determining a name in the identified structured representation to index by;
an act of generating an external data index of a plurality of unit portions of the external data that indexes by the determined name, the unit portion being measured common to a plurality of different formats of external data, the plurality of unit portions including unit portions of multiple different formats, the external data index usable to more quickly find unit portions that match one or more search criteria directed to the relational database system even though the external data source is outside of the relational database system, the act of generating the external data index comprising the following for each unit portion of the plurality unit portions:
an act of identifying a structured representation of the unit portion, the structured representation including a structural context of the determined name;
an act of reviewing the identified structured representation; and
in response to the act of reviewing and determining, an act of generating a portion of the external data index that maps a value of the name to the unit portion of the external data.
